(19) United States
(12) Patent Application Publication
(10) Pub. No.: US 2021/0291217 A1
(43) Pub. Date: Sep. 23, 2021

(54) Method and Apparatus for the Production of Doors

(71) Applicant: Edward Drees, Paramount, CA (US)

(72) Inventor: Edward Drees, Paramount, CA (US)

(21) Appl. No.: 17/183,032

(22) Filed: Feb. 23, 2021

Related U.S. Application Data
(60) Provisional application No. 62/993,438, filed on Mar. 23, 2020.

(51) Int. Cl. B05B 13/04; E06B 3/70; E06B 3/984; B05B 7/02

(52) U.S. Cl. CPC B05B 13/0405; E06B 3/70; E06B 2003/7061; B05B 7/02; E06B 3/984

(57) ABSTRACT

The present invention concerns the provision of a novel glue application apparatus for controllably depositing glue on the mating surfaces of door components in a manner that provides adequate glue coverage while preventing the deposition of excessive amounts of glue. The glue application apparatus includes multiple glue dispensers having uniquely configured glue dispensing nozzles that are uniquely positioned at various angles to accommodate mating surfaces of different profiles.

### CROSS-REFERENCE TO RELATED APPLICATIONS

This Application claims the benefit of U.S. Provisional Application No. 62/993,438 filed Mar. 23, 2020, which is incorporated by reference herein in its entirety.

### STATEMENT REGARDING FEDERALLY SPONSORED RESEARCH OR DEVELOPMENT

Not Applicable

### INCORPORATION-BY-REFERENCE OF MATERIAL SUBMITTED ON A COMPACT DISC

Not Applicable

### BACKGROUND OF THE INVENTION

### Field of the Invention

The present invention relates generally to the field of wood products. More particularly, the invention concerns methods and apparatus for the production of high quality cabinet doors, entry doors, passage doors, shutters, and the like.

### Discussion of the Prior Art

In the residential and commercial millwork industry, most natural and engineered wood frame components have mating surfaces that are bonded together using appropriate glues. These frame components typically are used to make doors and panel systems of various sizes and applications. The process of manufacturing cabinet doors, for example, requires the proper assembly protocol to achieve superior results in a high production environment.

The first step in carrying out the manufacturing process typically involves selection of the components of the door and the application of glue to the joint areas of the components. In the past, this glue application process was done with either a brush, a glue bottle, or an applicator with various tips designed for that purpose. Once the glue was applied, the parts were put together and placed in a clamp where the joints were closed tightly. Typically, while the door was under clamp pressure, small headless nails were shot into the joint area to lock it into place so that the pressure could be released and the door removed from the clamp.

These prior art procedures exhibited several drawbacks, including inferior gluing of the mating surfaces. In this regard, when the glue is applied, it must be of a sufficient quantity to cover the joint area in order to achieve a strong bond. Too little glue can undesirably cause a weak joint. This being the case, most applicators typically applied excessive amounts of glue. Accordingly, when pressure was applied by the clamping mechanism, this excess was squeezed out of the joint and was visible on the front and back of the door and had to be removed before hardening. Also, excess glue outside the joint can cause undesirable arcing when under RF radiation.

As previously mentioned, nailing the joints was necessary for quick removal of the door from the clamp, but the indentation left from the nailing step was visible. Additionally, the nails undesirably permitted some movement at the joint when the pressure from the clamp was released. Too much movement causes the joint to open, diminishing its strength. Also, nails that are not seated properly remain close to the surface. In practice, nearly all doors are sent through a wide belt sander to even the surfaces. During the sanding process, improperly seated nails can come in contact with the sandpaper causing a possible fire hazard and damage to the belt.

As will be discussed in greater detail in the paragraphs that follow, a primary object of the present invention is to provide a novel method and apparatus that will successfully overcome the drawbacks of the prior art including those set forth in the preceding paragraphs.

An important feature of the present invention involves the provision of a novel glue application apparatus for controllably depositing glue on the mating surfaces of the door components in a manner that provides adequate glue coverage while preventing the deposition of excessive amounts of glue. In a preferred form of the invention, the glue application apparatus includes multiple glue dispensers having uniquely configured glue dispensing nozzles that create a controlled spray pattern. The dispensing nozzles are uniquely positioned at various angles to accommodate mating surfaces of different profiles. The glue dispensers are mounted on a support in the form of a linear guided carriage and are propelled by a stepper drive system that enables precise control of the opening and closing of the nozzles.

Another important feature of the present invention involves the step of curing the glue lines in the wood joints of the doors by means of(RF) radiation. Radiofrequency (RF) energy applications use controlled electromagnetic radiation to heat items or to power all kinds of processes. Magnetron tubes commonly generate this energy. More recently, it has been generated by an all solid-state semiconductor chain. Solid-state RF energy offers numerous benefits unavailable via alternate solutions: low-voltage drive, semiconductor-type reliability, smaller form factor and an “all-solid-state electronics” footprint. Perhaps its most compelling attributes are fast frequency-, phase- and power-agility complemented by hyper-precision. Collectively, the technology's attributes yield an unprecedented process control range, even energy distribution, and fast adaption to changing load conditions. Additionally, solid-state RF driven applications benefit from very agile control of the created electromagnetic fields. In practice, when a liquid containing water is exposed to RF energy, the molecules become excited and vibrate rapidly generating heat from the friction. Most wood working glues are water based and heat up very quickly when exposed to RF energy causing an immediate bond to develop at the wood joints of the doors. This invention utilizes solid-state RF generation and enjoys all the benefits previously described herein.

### BRIEF SUMMARY OF THE INVENTION

By way of brief summary, the present invention comprises a method and apparatus for manufacturing superior quality natural and engineered wood doors in a high production environment. More particularly, the invention concerns a method and apparatus for manufacturing doors that comprise structural components having mated surfaces that are bonded together using appropriate glues.

With the foregoing in mind, it is an object of the present invention to provide a novel method and apparatus for depositing and curing the glue used to bond together the mating components of the door.

Another object of the invention is to provide a novel apparatus for applying a precise amount of glue to the mating surfaces of the components of the door in a manner to adequately cover the mating surfaces.

Another object of the invention is to provide a novel apparatus for applying a precise amount of glue to the mating surfaces of the components of the door in a manner to avoid excessive squeeze out of glue during the assembly of the components.

Another object of the invention is to provide a novel apparatus for quickly and easily clamping together the glued components of the door to provide a securely clamped assembly.

Another object of the invention is to provide a method and apparatus for quickly and efficiently curing the glue disposed within the mating surfaces of the glued components secured within the clamped assembly. More particularly, it is an object of the invention to provide a process and apparatus for curing the glue through the use of solid-state radiofrequency radiation.

The foregoing as well as other objects of the invention will be achieved by the methods and apparatus illustrated and described in the specification that follows.

### BRIEF DESCRIPTION OF SEVERAL VIEWS OF THE DRAWINGS

FIG. 1 is a generally diagrammatic view illustrating one form of the method of the invention for constructing a high quality door.

FIG. 2 is a generally diagrammatic view illustrating one form of the apparatus of the invention for constructing a high quality door.

FIG. 3 is a front view of one form of the apparatus of the invention for uniformly applying glue to the frame components of the door prior to their assembly.

FIG. 4 is a side elevational view of the apparatus shown in FIG. 3.

FIG. 5 is a greatly enlarged, fragmentary side view of three of the glue spray guns used in uniformly applying glue to the frame components illustrating the various angles and positions of the spray guns for applying glue to differently configured bonding surfaces of the frame components.

FIG. 6 is a top plan view of one form of the assembly table of the invention for assembling the frame components of the door prior to the accomplishment of the glue curing operation.

FIG. 7 is a side elevational view of the assembly table shown in FIG. 6.

FIG. 8 is a front view of one form of the clamping and glue curing apparatus of the invention for clamping the precursor frame assembly and curing the glued joints of the precursor frame assembly that is secured within the clamping assembly.

FIG. 9 is a side elevational view of the apparatus shown in FIG. 8.

FIG. 10 is a side elevational view of one form of the clamp/curing assembly of the invention for irradiating the glued joints of the precursor frame assembly that is secured within the clamping assembly.

FIG. 11 is a side elevational view of the clamp/curing assembly shown in FIG. 10.

### DETAILED DESCRIPTION OF THE INVENTION

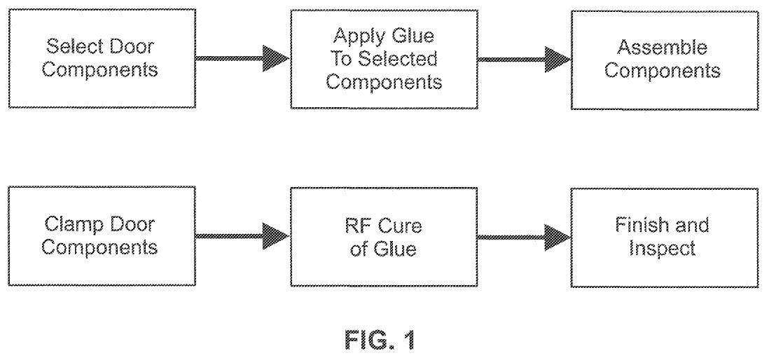

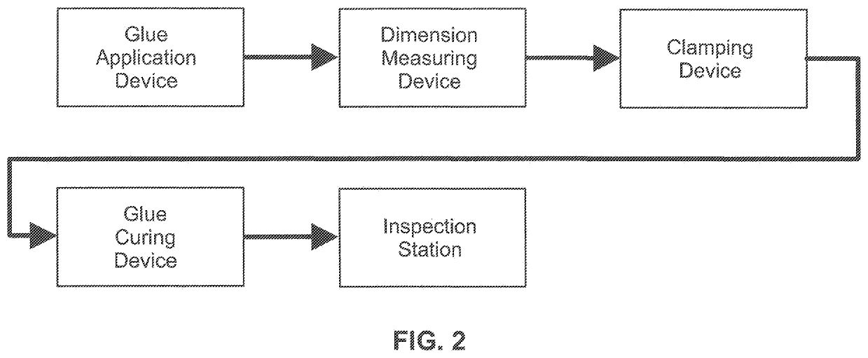

Referring to FIGS. 1 and 2 of the drawings, the major aspects of the present method and apparatus of the invention are there summarized. As previously mentioned, one of the important aspects of the method and apparatus of the invention relates to a method and apparatus for controllably depositing glue on the mating surfaces of the door components in a manner that provides adequate glue coverage while preventing the deposition of excessive amounts of glue. As will be discussed in greater detail in the paragraphs which follow, the glue application apparatus of the invention includes multiple angularly adjustable glue dispensers having uniquely configured glue dispensing nozzles that create a controlled spray pattern. The glue dispensers can be uniquely positioned at various angles to accommodate mating surfaces of different profiles. Another important aspect of the of the invention concerns the method and apparatus for curing the glue applied to the wood joints of the doors by means of radiofrequency radiation. As will be discussed in greater detail in the paragraphs which follow, most wood working glues, such as those used to bond together the mating joints of the frame components of the door, are water based and heat up very quickly when exposed to RF energy advantageously causing an immediate bond to develop at the wood joints of the doors.

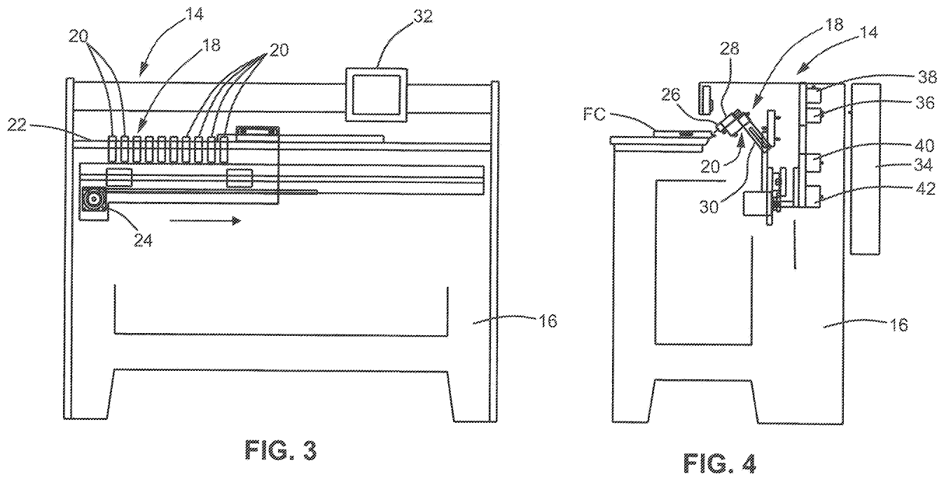

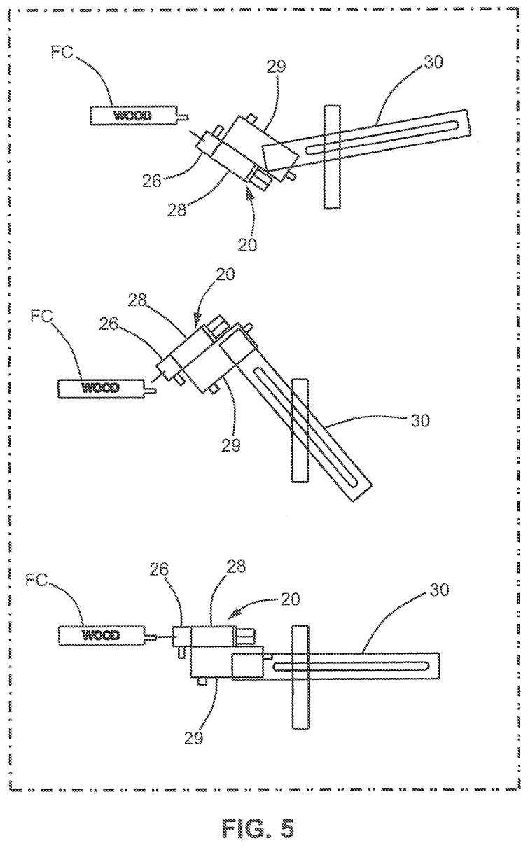

Referring next to FIGS. 3, 4 and 5 of the drawings, one form of the apparatus of the invention for uniformly applying glue to the frame components of the door is there shown and generally designated by the numeral 14. This important apparatus here includes a frame 16 that supports and houses the various components that function to uniformly apply glue to the frame components FC (FIG. 5) of the door. In this regard, it is important to note that a precise amount of glue be applied to the mating surfaces to avoid excessive squeeze out of glue when, in a manner presently to be described, the joint is closed by the clamping apparatus of the invention.

The glue application apparatus of the present form of the invention, which is generally identified by the numeral 18, comprises a plurality of angularly adjustable glue dispensers 20 that are mounted on a movable support or carriage 22 carried by frame 16 and disposed proximate the mating surfaces. Support 22 is here provided in the form of a linear guided carriage (FIG. 3). In the embodiment of the invention shown in the drawings, ten glue dispensers are shown. However, more or fewer dispensers can be provided depending on the complexity of frame components to be glued. Carriage 22 is propelled by a stepper drive 24 that functions to precisely control the opening and closing of custom nozzles or plastic tips 26 (FIG. 5) of the dispensers 20. Linear guided carriage 22 and stepper drive 24 are commercially available from various sources including the Hiwin Motion Control Company of Huntley, Ill. Glue dispensers 20, comprise a glue gun 28 that is available from several sources including the IMI Precision Engineering Company having offices at Medway, Mass. Glue guns 28 include a custom nozzle 26 that is specially designed to create a controlled pattern of the glue deposited on the mating surfaces of the frame components of the door. In the gluing operation, manifold 29 controllably distributes air and glue to the glue gun 28. As best seen in FIG. 5, each dispenser 20 is attached to a pivot arm 30 that is connected to support 22. Pivot arm 30 uniquely allows adjustment of the nozzle angle and depth to accommodate various mating surface profiles. In this regard, many mating surface profiles exist, so programs for each are developed in a manner well understood by those skilled in the art and are stored in a control panel 32 that is affixed to the front of the frame 16.

As best seen in FIG. 4 of the drawings, the glue that is deposited on the mating surfaces of the frame components of the door is stored and pressurized in the vessel 34 and transferred to a manifold 36 to provide glue distribution on demand via three-way air valves that are provided on each of the dispensers 20. In this regard, in the apparatus of the present form of the invention, each dispenser 20 is provided with two ports, one for pressurized glue and one for regulated air for opening valves for dispensing the glue.

Referring to FIGS. 3 and 4, a manifold 38, contains regulated compressed air that is controllably distributed to each of the dispensers 20 via individual two-way air valves. A manifold 40, which is affixed to support 22 is connected to a standard water source and to a regulated compressed air source via conventional two-way valves. When the manifold 40 valves are energized, the water/air combination is used to flush the tips of the nozzles 26 of the glue dispensers of any glue residue that may harden and clog the nozzles. Manifold 42, which is affixed to support 22, contains regulated compressed air that is distributed to the dispensers 20 via individual, conventional two-way air valves. This air is used to uniformly atomize the glue dispensed from the nozzles 26 of the glue dispensers in a manner to create the desired spray pattern that is to be applied to the mating surfaces of the frame components of the door.

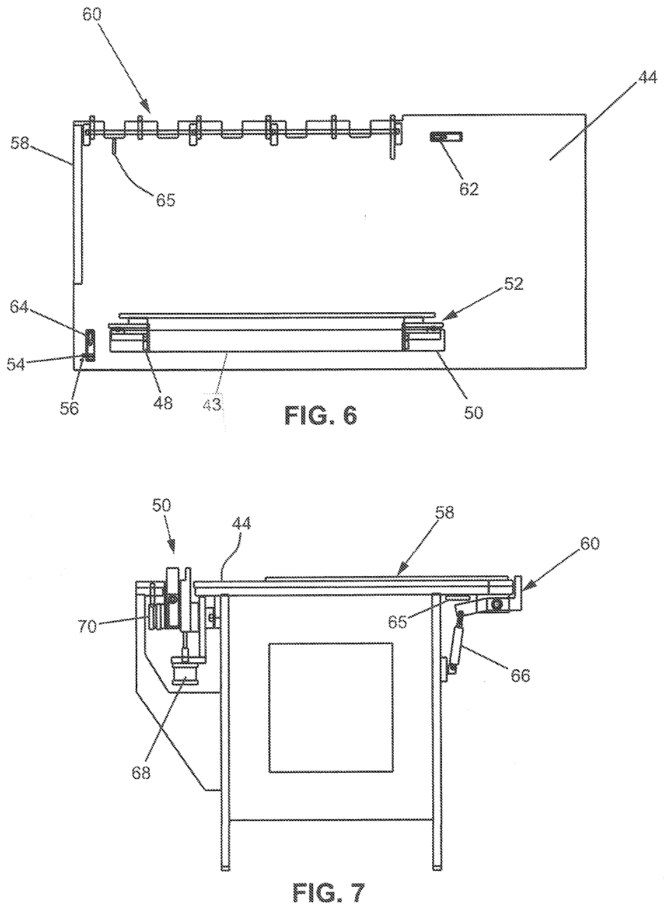

After glue is applied to the mating surfaces of the frame components to produce a plurality of glued components, the door must be assembled before being placed into the presently to be described clamp assembly of the invention. Assembly of the frame components to produce an assembled door frame is accomplished using the assembly apparatus of the invention, which is generally designated in FIG. 6 of the drawings by the numeral 43. Assembly apparatus 43 is mounted on a table 44. Forming a part of the assembly apparatus 43 are transversely spaced apart grippers 48 and 50. Grippers 48 and 50 function to hold a selected one of the glued door frame parts in place in a manner to allow the remainder of the parts to be expeditiously attached so as to form the precursor door frame. To accommodate various lengths of frame parts, gripper 50 is moveable along a linear guide 52. Movement of the gripper 50 into a gripping configuration is accomplished by the operator placing a hand in front of a readily commercially available sensor 54 which is mounted proximate the lower left-hand corner of table 44. Release of the gripper from the gripping configuration is accomplished by the operator once again placing a hand in front of sensor 54. By the operator placing a hand in front of readily commercially available sensor 56, which is also mounted proximate the lower left-hand corner of table 44, the grippers will be caused to drop and release thereby allowing the operator to easily remove the assembled door frame. Placing the hand again over sensor 56 brings the grippers once again into the up position to enable acceptance of another frame component.

After the door is assembled, it is placed against a fixed stop 58 and a retracting stop 60 both of which are provided proximate the upper left-hand portion of the table 44. In this position, the measurement of the width and length of the assembled door can be readily accomplished using measuring apparatus comprising commercially available sensors 62 and 64 that are mounted on table 44 in the manner shown in FIG. 6. By the operator placing a hand in front of a readily commercially available sensor 65 that is mounted on the table 44 proximate the retracting stop 60, the retracting stop can be retracted for easy removal of the precursor door frame and to send the size of the frame as measured by sensors 62 and 64 to the clamp servo controller the character of which will presently be described. During the operation of the assembly table, it is to be appreciated that the clamp corners open or close to the measured size to speed up production. As shown in FIG. 7 of the drawings, cylinders 66, 68 and 70, which are connected to frame 44 function to actuate movement of the grippers 48 and 50 and the stop 60. The various sensors used in the apparatus of the invention are readily commercially available from various sources including Baumer of Southington, Conn. and Keyence of Itasca, Ill.

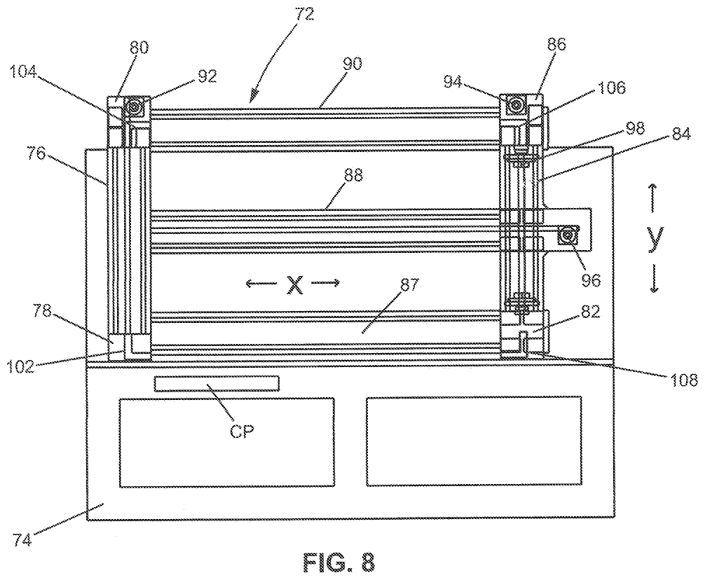

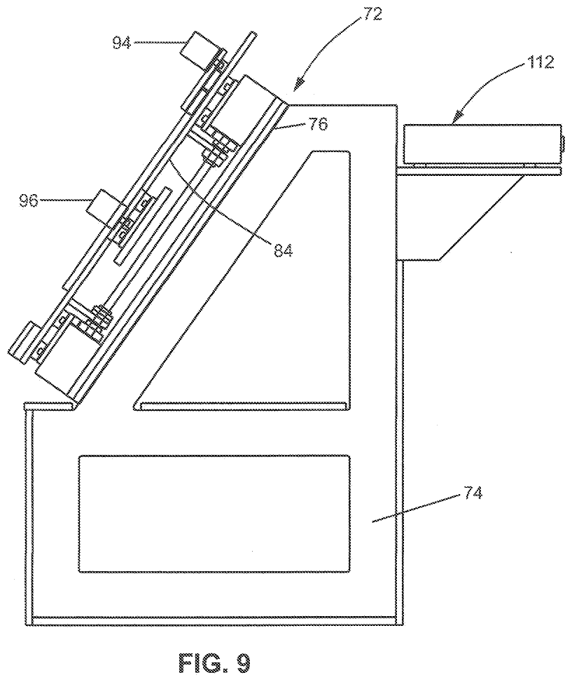

Referring now to FIGS. 8 and 9 of the drawings, one form of the precursor frame clamping apparatus of the invention is there shown and generally designated by the numeral 72. This important apparatus comprises a supporting frame 74 that, in a manner presently to be described, supports the various clamp plates, motors and drive systems that perform a controlled clamping action on the precursor door frame. More particularly, the clamping apparatus 72 here includes a first vertical plate 76 that is connected to and extends upwardly from a first fixed plate 78 that is carried by frame 74. Frame clamping apparatus 72 also includes a first clamp plate 80 that, as shown in FIG. 8, is movable in the Y direction from a first outward position to a second inward position. In FIG. 8, plate 80 is shown in the upper most outward position.

The clamping assembly further includes a fixed plate 82 and a vertical plate 84 that is connected to and extends upwardly from fixed plate 82. Additionally, the clamping assembly 72 also includes a plate 86 that as shown in FIG. 8 is movable in the Y direction. In FIG. 8, plate 86 is shown in the uppermost position. To enable horizontal movement, vertical plate 84 is attached to generally U-shaped linear guides 87, 88 and 90 that are affixed to frame clamping apparatus 72. Servo motor 92 drives first plate 80 via a conventional rack and pinion gear system. Similarly, servo motor 94 drives second plate 86 via a conventional rack and pinion gear system. Horizontal motion of horizontally movable vertical plate assembly 82 is accomplished by a servo motor 96 via a conventional rack and pinion system. A conventional duel rack and pinion system 98 maintains parallelism of vertical plate assembly 82 under clamp pressure. In operation of the clamping apparatus, first plate 80 and second plate 86 move synchronously. As first plate 80 is moved in the Y direction, and as vertical plate 84 is moved in the X direction, angular shaped corner clamps 102, 104, 106 and 108 move into the precursor frame assembly clamping position selected by the operator using the previous coordinates measured by sensors 62 and 64. A control panel, which is mounted on frame 74 and is here designated as “CP”, contains switches and knobs that set torque levels for precise control of clamping pressure, clamp motion start and emergency unclamp.

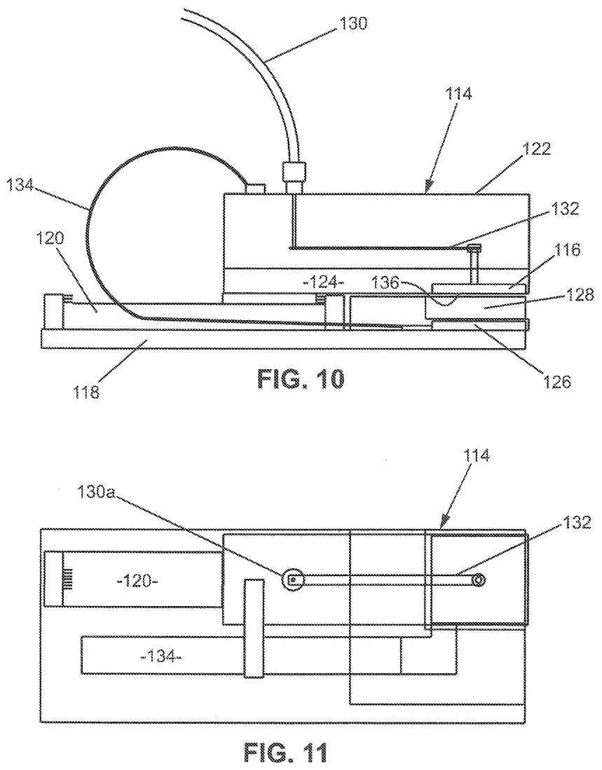

Turning now to FIGS. 9, 10 and 11, one form of the clamp/curing apparatus of the present invention is there shown. This novel apparatus here comprises a radiofrequency (RF) generator 112 (FIG. 9) and a plurality of glue curing, electrode positioning subassemblies 114. Subassemblies 114 cooperate with generator 112 to cure the glued joints of the precursor frame assembly when the glued joints are strategically positioned within the subassemblies 114 in a manner shown in FIG. 10. Subassemblies 114 also function to strategically position the hot electrode 116 over the glued corner joints of the precursor frame assembly that is secured within the clamping assembly 72. In the present form of the invention, each subassembly 114 comprises an aluminum base 118 that is mounted on the frame 74 of the clamping assembly at a location proximate each of the glued corner joints of the precursor frame assembly. Carried by aluminum base 118 is an air slide 120 to which a metal housing 122 and a plastic electrode holder 124 are slidably affixed. Metal housing 122 functions as an RF shield for the hot electrode 116 and plastic electrode holder 124 houses the hot electrode in the manner shown in FIG. 10. Also mounted on aluminum base 118 is a return electrode 126 which is operably associated with a hot electrode 116 to accomplish the RF glue curing process. As illustrated in FIG. 10 of the drawings, when a subassembly 114 is in a glue curing position, a glued joint of the precursor frame assembly, which is generally designated in FIG. 10 by the numeral 128, is strategically receivable between the hot and return electrodes 116 and 126. Also forming a part of the clamp/curing apparatus of the invention is a coaxial cable 130 that is connected to the generator 112 via a connector 130a (FIG. 11), a connector strip 132 and a coiled copper strip 134 that follows the housing 114 to its retracted position. Suitable radio frequency generators, such as generator 112, are readily commercially available from various sources including Coaxial Systems of Eastbourne, East Sussex, Great Britain.

In operation, when a precursor frame assembly resides in engagement with the angular shaped corner clamps 102, 104, 106 and 108, the clamp start button is pressed and the clamps are moved into pressural engagement with the precursor frame assembly. This done, the subassemblies 114 are advanced to a position wherein the glue joints 128 of the precursor frame assembly are received within the joint curing area 136 in the manner shown in FIG. 10. Advancement of the air slide 120 also causes the hot electrode 116 to advance to the position shown in FIG. 10. This done, the radiofrequency energy cures the glue over the preset time and the subassemblies 114 move back to the starting position. The pressure being exerted on the glued joints by the clamping apparatus can then be released permitting the completed frame assembly to be removed from the clamping apparatus.

Having now described the invention in detail in accordance with the requirements of the patent statutes, those skilled in this art will have no difficulty in making changes and modifications in the individual parts or their relative assembly in order to meet specific requirements or conditions. Such changes and modifications may be made without departing from the scope and spirit of the invention as set forth in the following claims.

1. An apparatus for producing a door from a plurality of door components, each door component having a mating surface, said apparatus comprising:
(a) a glue depositing apparatus for controllably depositing glue on the mating surfaces of said door components, said depositing apparatus including;
(i) a support disposed proximate said mating surfaces of said door components;
(ii) a plurality of spaced apart glue guns connected to said support, each of said glue guns including a spray nozzle for controllably depositing glue onto said mating surfaces of said door components to produce a plurality of glued components; and
(iii) a plurality of pivot arms connected to said support for movement between a first position and a second position, each of said plurality of glue guns being connected to a selected one of said pivot arms;
(b) a clamping assembly for pressing together selected glued components of said assembled doorframe to form a precursor door frame; and
(c) a glue curing apparatus for curing the glue deposited on said glue receiving surfaces of said glued components of said precursor door frame.

2. The apparatus as defined in claim 1 in which said glue depositing apparatus further includes a manifold operably associated with each of said glue guns for controllably distributing air and glue to said glue gun.

3. The apparatus as defined in claim 1 further including an assembly apparatus for assembling said glued components to produce an assembled doorframe.

4. The apparatus as defined in claim 1 in which said support of said glue depositing apparatus comprises a linear guide carriage.

5. The apparatus as defined in claim 1 in which said glue depositing apparatus further includes a plurality of pivot arms connected to said support for movement between a first position and a second position, a selected one of said plurality of glue guns being connected to a selected one of said pivot arms.

6. The apparatus as defined in claim 1 further including an apparatus for measuring the size of said precursor doorframe.

7. The apparatus as defined in claim 1 in which said clamping assembly comprises:
(a) a first clamp plate that is movable from a first outward position to a second inward position;
(b) a horizontally movable vertical plate assembly; and
(c) a second clamp plate connected to said horizontally movable plate assembly for movement from a first outward position to a second inward position.

8. The apparatus as defined in claim 6 further including a supporting frame and a plurality of generally U-shaped linear guides connected to said supporting frame, said horizontally movable vertical plate assembly being connected to said generally U-shaped linear guides.

9. The apparatus as defined in claim 1 in which said glue curing apparatus comprises a radio-frequency generator.

10. An apparatus for producing a door from a plurality of door components each door component having a mating surface, said apparatus comprising:
(a) a glue depositing apparatus for controllably depositing glue on the mating surfaces of said door components, said glue depositing apparatus including;
(i) a support disposed proximate said mating surfaces of said door components;
(ii) a plurality of spaced apart glue guns connected to said support, each of said glue guns including a spray nozzle for controllably depositing glue onto said mating surfaces of said door components to produce a plurality of glued components; and
(iii) a plurality of pivot arms connected to said support for movement between a first position and a second position, each of said plurality of glue guns being connected to a selected one of said pivot arms;
(b) a clamping assembly for pressing together selected glued components of said assembled doorframe to form a precursor door frame; and
(c) a glue curing apparatus for curing the glue deposited on said glue receiving surfaces of said glued components of said precursor door frame, said glue curing apparatus comprising a radio-frequency generator.

11. The apparatus as defined in claim 10 in which said glue depositing apparatus further includes a manifold operably associated with each of said glue guns for controllably distributing air and glue to said glue gun.

12. The apparatus as defined in claim 10 further including an assembly apparatus for assembling said glued components to produce an assembled doorframe.

13. The apparatus as defined in claim 1 in which said support of said glue depositing apparatus comprises a linear guide carriage.

14. The apparatus as defined in claim 10 further including an apparatus for measuring the size of said precursor doorframe.

15. The apparatus as defined in claim 10 in which said clamping assembly comprises:
(a) a first clamp plate that is movable from a first outward position to a second inward position;
(b) a horizontally movable vertical plate assembly; and
(c) a second clamp plate connected to said horizontally movable plate assembly for movement from a first outward position to a second inward position.

16. The apparatus as defined in claim 15 further including a supporting frame and a plurality of generally U-shaped linear guides connected to said supporting frame, said horizontally movable vertical plate assembly being connected to said generally U-shaped linear guides.

17. A method of door production comprising:
(a) providing an assembly comprising a plurality of door components each having a mating surface;
(b) using selected ones of a plurality of angularly disposed glue dispensers, depositing a layer of glue on said mating surfaces of said selected ones of said plurality of door components to form a plurality of glued door components;
(c) moving said mating surfaces of said glued door components into engagement to form a precursor door assembly; and
(d) heating said precursor door assembly to the glue on said glued door components to produce a bonded door.

18. The method as defined in claim 17 in which said precursor door assembly is heated with radiofrequency waves.

19. The method as defined in claim 17 further including the step of measuring the size of said precursor door assembly prior to heating said precursor door assembly.

20. The method as defined in claim 17 further including the step of prior to heating said precursor door assembly, placing said precursor door assembly into a clamping assembly and controllably exerting pressure on the mating surfaces of said door components of said precursor door assembly.
